(19) United States
(12) Patent Application Publication
(10) Pub. No.: US 2018/0229169 A1
(43) Pub. Date: Aug. 16, 2018

(54) AIR FILTER INCLUDING ADHESIVE AND METHOD OF MANUFACTURING THE SAME

(71) Applicant: Hean Soo PARK, Seoul (KR)

(72) Inventor: Hean Soo PARK, Seoul (KR)

(21) Appl. No.: 15/889,163

(22) Filed: Feb. 5, 2018

(30) Foreign Application Priority Data
Feb. 13, 2017 (KR) 10-2017-0019170

(51) Int. Cl. B01D 46/00; B01D 46/10

(52) U.S. Cl. CPC B01D 46/0001; A62B 23/025; B01D 2275/10; B01D 46/10

(57) ABSTRACT

Disclosed herein are an air filter and a method of manufacturing the air filter. The air filter includes a filter fabric, and an adhesive applied to the interior and the exterior of a filter fabric by means of a spray method, and the adhesive is an adhesive material which is maintained in a gel state after the curing of the adhesive material has been completed, and is adhered to surround the fabric fibers of the filter fabric. The method of manufacturing the air filter includes preparing a filter fabric having voids, and spraying an adhesive to the interior and the exterior of a filter fabric, and the adhesive is an adhesive material which is maintained in a gel state when the curing of the adhesive material has been completed.

### BACKGROUND

### 1. Technical Field

The present invention relates generally to an air filter including an adhesive and a method of manufacturing the air filter, and more specifically to an air filter in which a removal adhesive is applied to the interior and the exterior of a filter fabric to thus improve filtering performance and a method of manufacturing the air filter.

### 2. Description of the Related Art

With the development of industry, the contamination of the air in residential areas as well as the contamination of the air in industrial areas has gradually become serious due to the concentration of population into cities and the rapid population of automobiles. Furthermore, the overall Korea is frequently covered with the yellow dust from China, and thus the contamination of the air has become more serious. Such fine dust frequently causes respiratory diseases and skin-related diseases, such as colds, bronchitis, atopic dermatitis, etc.

Accordingly, various types of air purifiers capable of purifying air have been popularized in various types of large-sized buildings, industrial sites and common homes, and various types of masks are provided so as to prevent fine dust from being inhaled during going out.

Such air purifiers and masks need to essentially include air filters configured to filter out fine dust. Conventional air filters are configured to simply have fine voids so that air can pass through the air filters and dust having sizes equal to or larger than a predetermined size cannot pass through the air filters. The conventional air filters are typically configured such that the permeability thereof is determined based on the sizes of the voids thereof.

Therefore, as the size of the voids of such an air filter decreases, the size of fine dust which can be filtered out decreases. In order to manufacture an air filter having small voids, there is difficulty manufacturing the air filter and there is a technical limitation on manufacturing the air filter, and thus a disadvantage arises in that manufacturing cost is significantly increased. Furthermore, when the size of the voids of an air filter is decreased, dust filtering performance is increased, but air permeability is decreased, with the result that a problem arises in that the usability of the air filter is degraded. For example, when a mask is formed of an air filter having significantly small voids, a disadvantage arises in that it is difficult for a user who wears the mask to breathe through the mask, and thus it is impossible to wear the mask for a long period of time.

In order to overcome the above problem, i.e., in order to improve filtering performance while maintaining the size of voids equal to or larger than a predetermined size, an electrostatic air filter capable of drawing fine dust by means of static electricity and filtering out the dust was proposed in Korean Patent No. 10-0310274. The electrostatic air filter is configured such that static electricity is generated on filter fibers and, thus, even fine dust having sizes smaller than that of internal voids is attached by means of static electricity and filtered out. Accordingly, the electrostatic air filter is advantageous in that even when the size of voids is not considerably small, even fine dust can be filtered out.

However, in order to manufacture the conventional electrostatic air filter, there are required the steps of performing impregnation with polymer resin and performing discharge under a corona discharger. Accordingly, the conventional electrostatic air filter is disadvantageous in that the manufacturing process thereof is considerably complex, the manufacturing efficiency thereof is significantly low, and the manufacturing cost thereof is high, with the result that there is a limitation in terms of commercialization.

### SUMMARY

The present invention has been conceived to overcome the above-described problems, and an object of the present invention is to provide an air filter which is capable of efficiently filtering out fine dust while ensuring the size of voids equal to or larger than a reference value, and which is capable of simplifying a manufacturing process, thereby improving manufacturing efficiency and also reducing manufacturing cost.

According to an aspect of the present invention, there is provided a method of manufacturing an air filter, the method including: preparing a filter fabric having voids; and spraying an adhesive to the interior and the exterior of a filter fabric; wherein the adhesive is an adhesive material which is maintained in a gel state when the curing of the adhesive material has been completed.

The method may further include attaching an additional fabric or mesh to the the interior and the exterior of a filter fabric, to which the adhesive has been sprayed, by means of a stacking method.

The method may further include forming a powder layer on the the interior and the exterior of a filter fabric, to which the adhesive has been applied, by applying a non-adherent powder on the the interior and the exterior of a filter fabric.

According to another aspect of the present invention, there is provided an air filter including: a filter fabric; and an adhesive applied to the interior and the exterior of a filter fabric by means of a spray method; wherein the adhesive is an adhesive material which is maintained in a gel state after the curing of the adhesive material has been completed, and is adhered to surround the fabric fibers of the filter fabric.

The air filter may further include an additional fabric or mesh attached to the the interior and the exterior of a filter fabric, to which the adhesive has been sprayed, by means of a stacking method.

The air filter may further include an additional fabric attached to the the interior and the exterior of a filter fabric, to which the adhesive has been sprayed, by means of a stacking method, and the adhesive may be additionally applied to the outer surface of the additional fabric.

The air filter may further include a powder layer applied to the the interior and the exterior of a filter fabric to which the adhesive has been sprayed, and the powder layer may be made of a non-adherent powder.

The filter fabric may be a nonwoven fabric material.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a process of manufacturing an air filter according to the present invention;

FIG. 2 is a vertical sectional view of an air filter according to the present invention;

FIG. 3 is an enlarged view showing a state in which an adhesive has been applied to a filter fabric;

FIG. 4 is a vertical sectional view showing an air filter according to a second embodiment of the present invention;

FIG. 5 is a vertical sectional view showing an air filter according to a third embodiment of the present invention;

FIG. 6 is a vertical sectional view showing an air filter according to a fourth embodiment of the present invention; and

FIG. 7 is a vertical sectional view showing an air filter according to a fifth embodiment of the present invention.

### DETAILED DESCRIPTION

An air filter and a method of manufacturing the air filter according to embodiments of the present invention will be described in detail below with reference to the accompanying drawings.

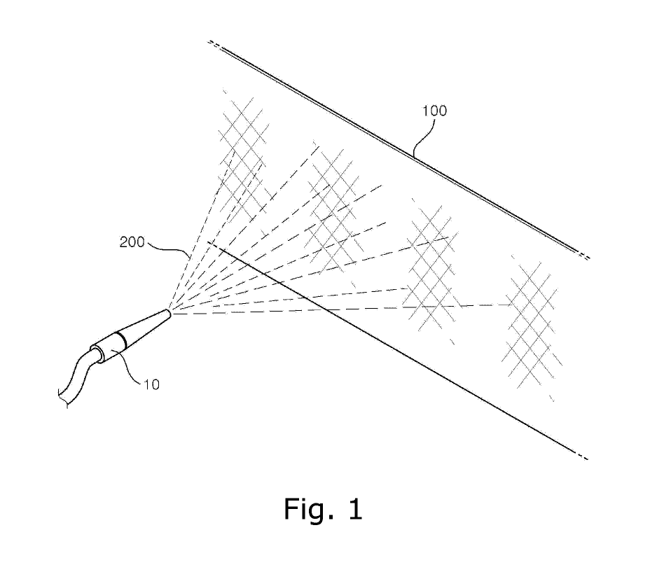

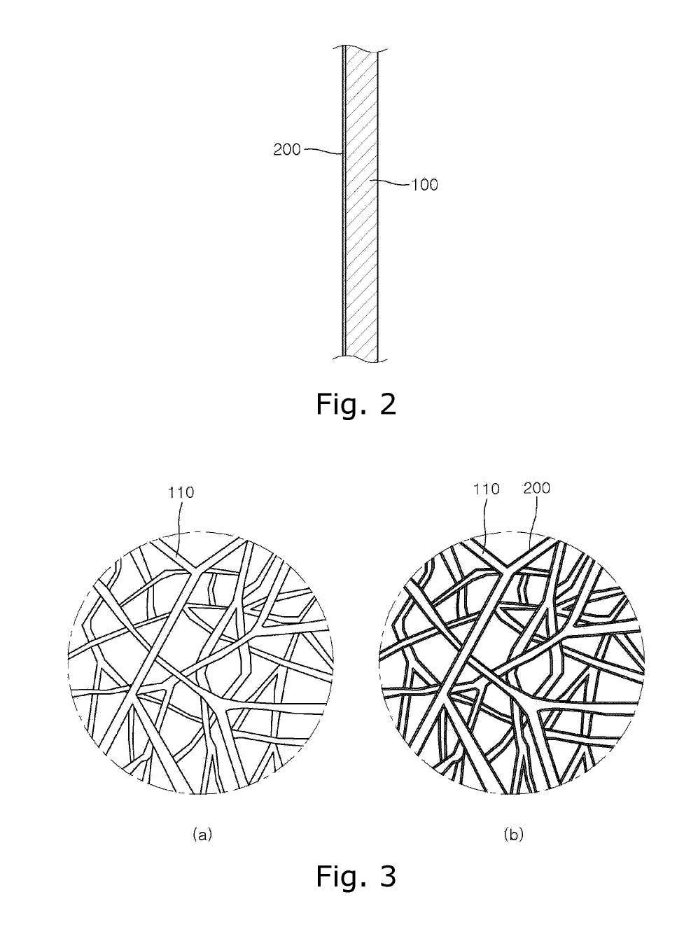

FIG. 1 is a perspective view showing a process of manufacturing an air filter according to the present invention, FIG. 2 is a vertical sectional view of an air filter according to the present invention, and FIG. 3 is an enlarged view showing a state in which an adhesive has been applied to a filter fabric.

An air filter according to the present embodiment is a type of air filter which filters out fine dust in the air. The air filter is configured to effectively filter out fine dust having a considerably small size while including voids having a size equal to or larger than a reference value. The air filter according to the present embodiment is characterized in its configuration in that it has a considerably simple structure and is configured to be easily manufactured.

In other words, the air filter according to the present embodiment includes a filter fabric 100 made of a nonwoven fabric material and an adhesive 200 applied to the interior and the exterior of a filter fabric 100. An adhesive material which is maintained in a gel state after the curing thereof has been completed is selected as the material of the adhesive 200.

Although the nonwoven fabric has been described as an example of the material of the filter fabric 100, the material of the filter fabric 100 is not limited thereto as long as a material can be installed in the air filter.

The above-described adhesive material which is maintained in a gel state refers to an adhesive material which, even when it has been cured for a long period of time, is not solidified but is maintained in a gel state having a specific level of adhesiveness, and is called a “removal adhesive.” It will be apparent that when the adhesive 200 is in a gel state, it is impossible to spray the adhesive 200 by means of a spray gun 10 by using a spray method, and thus the adhesive 200 which is fed to the spray gun 10 needs to be provided in a liquid state.

Although the fabric fibers 110 of the filter fabric 100 are formed to have large voids, as shown in FIG. 3(a), the adhesive 200 is applied to surround the fabric fibers 110, as shown in FIG. 3(b) after the adhesive 200 has been applied to the interior and the exterior of a filter fabric 100. In this case, an advantage arises in that the voids of the filter fabric 100 are decreased, i.e., in that fine dust having a smaller size can be effectively filtered out.

Furthermore, even when a long period of time has elapsed, the adhesive 200 which surrounds the fabric fibers 110 is not solidified, but is maintained in a gel state. The adhesive 200 which is maintained in a gel state can continuously maintain adhesive force, and thus an effect can be achieved in that fine dust is adhered to the adhesive 200. In other words, when the size of fine dust flowing into the air filter according to the present embodiment is smaller than that of the voids of the fabric fiber 110s which is surrounded by the adhesive 200, the fine dust passes through the air filter according to the present embodiment when the adhesive 200 is solidified, but is adhered to the adhesive 200 upon coming into contact with the adhesive 200 when the adhesive 200 is maintained in a gel state. In this case, an effect can be achieved in that fine dust cannot pass through the air filter according to the present embodiment.

When the method of manufacturing an air filter according to the present invention is used as described above, the size of voids can be reduced through the application of the adhesive 200 even when the filter fabric 100 having larger voids is used, and thus an advantage arises in that an air filter having excellent filtering performance per cost can be manufactured. Furthermore, the manufacture of the air filter according to the present embodiment is completed only through a process of spraying the adhesive 200 to the filter fabric 100, and thus advantages arise in that manufacturing efficiency is high and manufacturing cost is low, with the result that applicability to the markets is excellent.

The air filter manufactured as described above may be applied as a filter for an air filter, an air purifier, or the like. When the filter fabric 100 and the adhesive 200 are made of environment-friendly materials which are harmless to a human body, the air filter may be used for a product which comes into direct contact with the skin of a user, such as a mask, a bandage, or the like. In this case, the adhesive 200 in a gel state, which is harmless to a human body and maintains adhesiveness for a long period of time, has been commercialized for various purposes in the technical field to the present invention pertains. Detailed descriptions of the components and physical characteristics of the adhesive 200 are omitted.

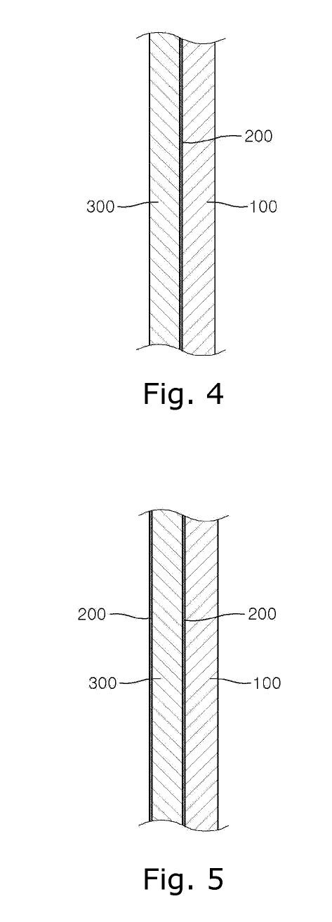

FIG. 4 is a vertical sectional view showing an air filter according to a second embodiment of the present invention, and FIG. 5 is a vertical sectional view showing an air filter according to a third embodiment of the present invention.

When the adhesive 200 applied to the interior and the exterior of a filter fabric 100 is exposed to the outside, impurities having sizes up to a size which allows impurities to be sufficiently filtered out only by the filter fabric 100 are adhered to the adhesive 200, and thus there is concern that the filtering performance of the air filter according to the present embodiment is degraded. Furthermore, when the air filter according to the present embodiment is used for a purpose requiring direct contact with the skin of a user, such as the purpose of a mask or bandage, there is concern that displeasure may be caused because the adhesive 200 comes into direct contact with the skin of the user.

Accordingly, an air filter according to the present embodiment is configured such that an additional fabric 300 may be attached to the interior and the exterior of a filter fabric 100, to which an adhesive 200 has been sprayed, by means of a stacking method in order to prevent the adhesive 200 from being directly exposed to the outside, as shown in FIG. 4. The additional fabric 300 may be any type of fabric as long as the type of fabric has voids through which air can pass. The additional fabric 300 may be made of the same nonwoven fabric as the filter fabric 100.

When the adhesive 200 is covered with the separate additional fabric 300, advantages arise in that there can be prevented the phenomenon in which large impurities are attached to the adhesive 200 or in that there can be prevented the displeasure which occurs when the adhesive 200 comes into direct contact with the skin of a user. Furthermore, when the adhesive 200 is provided between the filter fabric 100 and the additional fabric 300, impurities larger than the voids of the filter fabric 100 and the additional fabric 300 are filtered out by the filter fabric 100 and the additional fabric 300, and only fine dust smaller than the voids of the filter fabric 100 and the additional fabric 300 are adhered to the adhesive 200. In this case, an effect can be achieved in that the life span of the air filter according to the present embodiment can be considerably increased.

Meanwhile, in order to further enhance the filtering performance of an air filter according to the present embodiment, an adhesive is additionally applied to the outer surface (the left surface in the present embodiment) of the additional fabric 300 in the state shown in FIG. 4, and thus the adhesives 200 may be formed in two layers, as shown in FIG. 5. When the fabrics are provided in two layers and the adhesives 200 are provided in two layers, as described above, an advantage can be provided in that filtering performance becomes twice that of the embodiment shown in FIG. 2. In this case, when the additional fabric 300 is made of the same material as the filter fabric 100, the air filter shown in FIG. 5 may be fabricated by superimposing two air filters, shown in FIG. 2, on each other.

When the air filter according to the present embodiment is manufactured such that each of the fabrics 100 and 300 and the adhesives 200 is formed in two layers, as shown in FIG. 5, and a specific period has elapsed, the fabric and the adhesive 200 on the side through which air flows is more contaminated, whereas the fabric and the adhesive 200 on the opposite side are less contaminated. Accordingly, after a user has used the air filter according to the present embodiment, only the more contaminated fabric and adhesive 200 may be replaced and the less contaminated fabric and adhesive 200 may be reused, with the result that an effect can be achieved in that repair and maintenance cost is reduced.

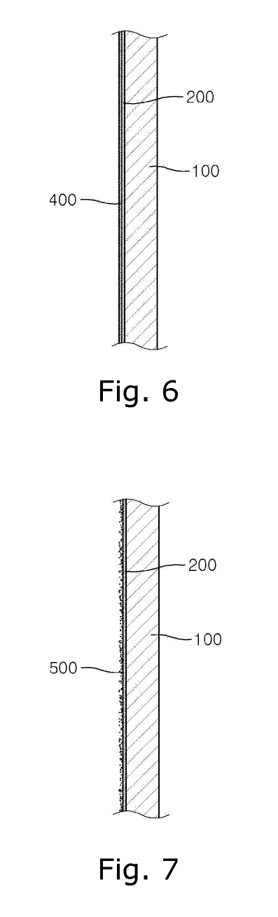

FIG. 6 is a vertical sectional view showing an air filter according to a fourth embodiment of the present invention.

When the fabrics are stacked on each other in two layers, as in the embodiments shown in FIGS. 4 and 5, air permeability is degraded, and thus it may be difficult to apply the air filter to an air filter or air purifier. In order to maintain air permeability at or above a reference value while preventing an adhesive 200 from being directly exposed to the outside, the air filter according to the present embodiment may be configured such that a mesh 400 may be attached on the interior and the exterior of a filter fabric 100, to which an adhesive 200 has been sprayed, by means of a stacking method, as shown in FIG. 6.

Since the mesh size of the mesh 400 is considerably larger than that of the voids of the filter fabric 100, the mesh 400 rarely has air filtering performance, but has only a function of protecting the adhesive 200 by covering it. Accordingly, the air filter having the structure in which the mesh 400 is additionally stacked on one side of the filter fabric 100 prevents the adhesive 200 from being unnecessarily contaminated by preventing the adhesive 200 from being exposed to the outside direct, and maintains overall air permeability at a high level. Therefore, an advantage arises in that the air filter can be used for a filtration purpose requiring a large air flow rate per time.

In this case, the mesh 400 may be manufactured using any type of metal or synthetic resin. However, when the air filter according to the present embodiment is used for a purpose requiring direct contact with the body of a user, such as the purpose of a mask, a bandage, or the like, it is preferred that the mesh 400 may be fabricated of a metal harmless to a human body, such as gold, silver or the like, or an environment-friendly synthetic resin, such as silicon or the like.

FIG. 7 is a vertical sectional view showing an air filter according to a fifth embodiment of the present invention.

In the case where the fabric 300 or mesh 400 is additionally stacked in order to prevent the adhesive 200 from being exposed to the outside, the additional fabric 300 or mesh 400 needs to be separately fabricated and the additional fabric 300 or mesh 400 needs to be attached at an appropriate location, with the result that there occurs difficulty fabricating the air filter.

Accordingly, in order to prevent the adhesive 200 from being exposed to the outside even when a separate sheet is not stacked on the interior and the exterior of a filter fabric 100 to which the adhesive 200 has been applied, the air filter according to the present embodiment may be configured such that a thin powder layer 500 may be formed on the interior and the exterior of a filter fabric 100, to which the adhesive 200 has been sprayed, by applying a non-adherent powder to the surface of the filter fabric 100.

When the powder layer 500 is configured to cover the outer side (the left side in the present embodiment) of the adhesive 200, an advantage arises in that the adhesive can be protected regardless of the shape of the filter fabric 100, and an advantage also arises in that manufacturing cost can be reduced and manufacturing efficiency can be improved compared to the embodiment in which the additional fabric 300 or mesh 400 is stacked.

In this case, the powder layer 500 may be made of any type of powder as long as the powder has no adhesiveness while being harmless to a human body.

The air filter according to the present invention has an advantage of efficiently filtering out fine dust while ensuring the size of voids equal to or larger than a reference value, and also has an advantage of simplifying a manufacturing process, thereby improving manufacturing efficiency and also reducing manufacturing cost. Furthermore, the method of manufacturing the air filter according to the present invention has an advantage of manufacturing an air filter having high filtering performance by using a filter fabric having large voids, and also has an advantage of improving air filter manufacturing efficiency and also reducing air filter manufacturing cost.

While the present invention has been described in detail below with reference to the preferred embodiments, the scope of the present invention is not limited to the specific embodiments, but may be interpreted based on the attached claims. Furthermore, it will be appreciated by those having ordinary knowledge in the art to which the present invention pertains that many modifications and alterations may be made without departing from the spirit of the present invention.

What is claimed is:

1. A method of manufacturing an air filter, the method comprising:
preparing a filter fabric having voids; and
spraying an adhesive to the interior and the exterior of a filter fabric;
wherein the adhesive is an adhesive material which is maintained in a gel state when curing of the adhesive material has been completed.

2. The method of claim 1, further comprising attaching an additional fabric or mesh to the the interior and the exterior of a filter fabric, to which the adhesive has been sprayed, by means of a stacking method.

3. The method of claim 1, further comprising forming a powder layer on the the interior and the exterior of a filter fabric, to which the adhesive has been applied, by applying a non-adherent powder on the the interior and the exterior of a filter fabric.

4. An air filter comprising:
a filter fabric; and
an adhesive applied to the interior and the exterior of a filter fabric by means of a spray method;
wherein the adhesive is an adhesive material which is maintained in a gel state after curing of the adhesive material has been completed, and is adhered to surround fabric fibers of the filter fabric.

5. The air filter of claim 4, further comprising an additional fabric or mesh attached to the the interior and the exterior of a filter fabric, to which the adhesive has been sprayed, by means of a stacking method.

6. The air filter of claim 4, further comprising an additional fabric attached to the the interior and the exterior of a filter fabric, to which the adhesive has been sprayed, by means of a stacking method, wherein the adhesive is additionally applied to an outer surface of the additional fabric.

7. The air filter of claim 4, further comprising a powder layer applied to the the interior and the exterior of a filter fabric to which the adhesive has been sprayed, wherein the powder layer is made of a non-adherent powder.

8. The air filter of claim 4, wherein the filter fabric is a nonwoven fabric material.
